(19) United States
(12) Patent Application Publication
(10) Pub. No.: US 2013/0257054 A1
(43) Pub. Date: Oct. 3, 2013

(54) Gas Turbine - Variable Frequency Transformer Power Systems and Methods

(71) Applicant: Noémie Dion Ouellet, Greenville, SC (US)

(72) Inventor: Noémie Dion Ouellet, Greenville, SC (US)

(73) Assignee: GENERAL ELECTRIC COMPANY, Schenectady, NY (US)

(21) Appl. No.: 13/434,819

(22) Filed: Mar. 29, 2012

(51) Int. Cl. F01D 15/10; H02P 11/00

(52) U.S. Cl. 290/52; 60/793; 60/773; 363/102

(57) ABSTRACT

Systems and methods are provided that include a gas turbine, a generator coupled to the gas turbine and configured to generate a first electrical power output, and a variable frequency transformer coupled to the generator and configured to be coupled to an electrical grid such that the variable frequency transformer is configured to transform the first electrical power output into a second electrical power output having one or more power characteristics that correspond to the electrical grid.

### BACKGROUND OF THE INVENTION

The subject matter disclosed herein relates to gas turbine systems and, more particularly, to a gas turbine system coupled to an electrical grid via a variable frequency transformer that complies with electrical grid code specifications.

Various countries have different electrical grid code regulations that specify the output of power generating assets connected to an electrical grid. A common electrical grid code regulation specifies an amount of power that a power-generating asset (e.g., gas turbine-generator) supplies the electrical grid during an under-frequency event. These electrical grid code regulations are generally used to prevent excessive active power dips during under-frequency events. Gas turbines are particularly sensitive to grid frequency reduction, which may result in marked power output changes that vary with ambient temperature. In general, the electrical grid code under-frequency power regulations can be met by increasing the power output by the gas turbine by injecting water or steam into the gas turbine, altering a firing temperature of the gas turbine, or conditioning the gas turbine's inlet air. Unfortunately, these processes add costs, have slow response times, cause damage to combustion and hot gas path hardware inside the gas turbine, and do not prevent the decreasing overall efficiency of the gas turbine due to the under frequency events.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine, a generator coupled to the gas turbine and configured to generate a first electrical power output, and a variable frequency transformer coupled to the generator and an electrical grid. Here, the variable frequency transformer may be configured to transform the first electrical power output into a second electrical power output having one or more power characteristics that correspond to the electrical grid.

In a second embodiment, a non-transitory computer-readable medium may include computer executable instructions that may be executed by a processor such that the processor may receive a power command having an electrical power output value for a variable frequency transformer such that the variable frequency transformer may receive a first electrical power from a gas turbine generator. The processor may then send a first command to the variable frequency transformer to adjust a second electrical power from the variable frequency transformer to substantially match the electrical power output value. Here, the variable frequency transformer may automatically compensate for a difference between a first frequency of the first electrical power and a second frequency of the second electrical power while adjusting the second electrical power to substantially match the electrical output value.

In a third embodiment, a method for generating power may include (a) receiving a first frequency that corresponds to a frequency of an electrical grid; (b) receiving a second frequency that corresponds to an electric power output by a generator coupled to a gas turbine and a variable frequency transformer such that the variable frequency transformer is coupled to the electrical grid; (c) generating a gas turbine speed setpoint if a difference between the first frequency and the second frequency is greater than a predetermined value; (d) sending the gas turbine speed setpoint to the gas turbine; (e) repeating steps (a)-(d) until the difference is less than or equal to the predetermined value; and (f) sending a command to the variable frequency transformer to adjust an electric power output by the variable frequency transformer to substantially match an electric power output value specified by a power command.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a simplified block diagram of a gas turbine in a gas turbine-variable frequency transformer (VFT) system, in accordance with an embodiment;

FIG. 2 is a simplified block diagram of a variable frequency transformer (VFT) in a gas turbine-VFT system, in accordance with an embodiment;

FIG. 3 is a simplified block diagram of a gas turbine-VFT control system, in accordance with an embodiment;

FIG. 4 is a data flow diagram for adjusting a frequency of a power output by a gas turbine-VFT system, in accordance with an embodiment.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

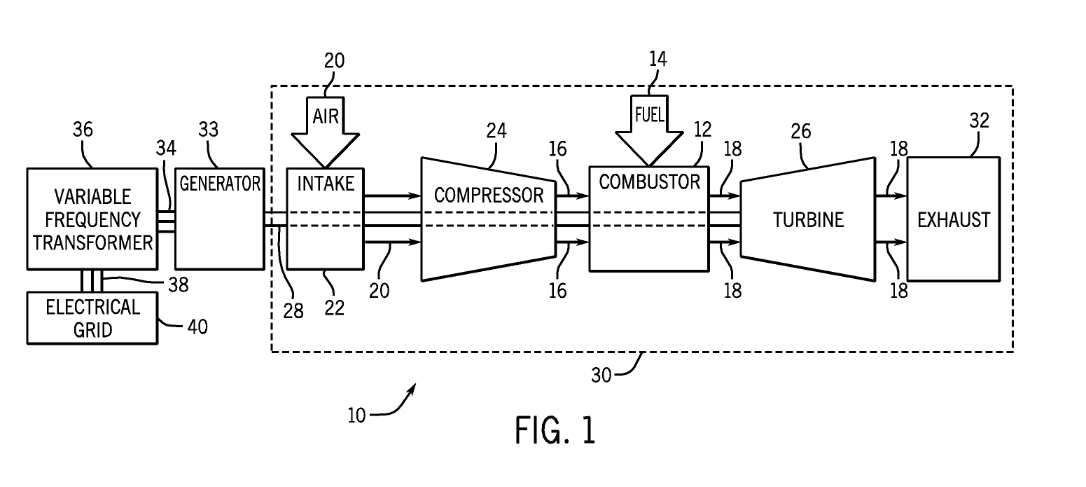

Referring first to FIG. 1, a block diagram of an embodiment of gas turbine-VFT system 10 that may incorporate one or more aspects of the presently disclosed technologies or techniques is illustrated. The gas turbine-VFT system 10 includes a gas turbine 30 that may be, for example, part of a simple cycle system or a combined cycle system. The gas turbine 30 includes a combustor 12 that combusts fuel 14 to drive the gas turbine 30. According to certain embodiments, the fuel 14 may be a liquid or gaseous fuel, such as natural gas, light or heavy distillate oil, naphtha, crude oil, residual oil, or syngas.

Within the combustor 12, the fuel 14 may mix with pressurized air 16, shown by arrows, and ignition may occur, producing hot combustion gases 18 that power the gas turbine 30. The combustor 12 may include sector fuel nozzles that pre-mix the fuel 14 and the pressurized air 16 and direct the fuel-air mixture into a combustion chamber in a suitable ratio for optimal combustion, emissions, fuel consumption, and power output. Further, the sector nozzles (not shown) also may include liquid fuel cartridges that direct liquid fuel into the combustion chamber.

The pressurized air 16 includes intake air 20 that enters the gas turbine system 10 through an air intake section 22. The intake air 20 is compressed by a compressor 24 to produce the pressurized air 16 that enters the combustor 12. The sector fuel nozzles may direct the fuel 14 and the pressurized air 16 into a combustion zone of the combustor 12. Within the combustion zone, the pressurized air 16 combusts with the fuel 14 to produce the hot combustion gases 18. From the combustor 12, the hot combustion gases 18 may flow through a turbine 26 that drives the compressor 24 via a shaft 28. For example, the combustion gases 18 may apply motive forces to turbine rotor blades within the turbine 26 to rotate the shaft 28. The shaft 28 also may be connected to a generator 33 which may be used to generate electrical power on power lines 34. After flowing through the turbine 26, the hot combustion gases 18 may exit the gas turbine system 10 through an exhaust section 32. Although the shaft 28 is described as being connected to the generator 33 on the compressor 24 side of the shaft 28 (i.e., cold-end drive), in other embodiments the generator 33 may be connected to the turbine 26 end of the shaft 28 (i.e., hot-end drive).

As mentioned above, the generator 33 produces electrical power, which may be directed to a variable frequency transformer (VFT) 36 via power lines 34. The VFT 36 receives the electrical power and outputs electrical power onto power lines 38, which is coupled to the electrical grid 40. While the gas turbine-VFT system 10 is connected to the electrical grid 40, the gas turbine 30 may be operating in an islanding mode such that the gas turbine 30 may maintain a turbine speed and the VFT 36 may be seen as a variable load from the gas turbine's perspective.

In operation, the VFT 36 may transform the electrical power from the generator 33 into electrical power that is coupled to the electrical grid 40 such that the electrical power characteristics from the generator 33 matches the electrical power characteristics of the electrical grid 40. As such, the VFT 36 provides a means to control power flow between the generator 33 and the electrical grid 40 thereby facilitating the exchange of power between two asynchronous AC systems.

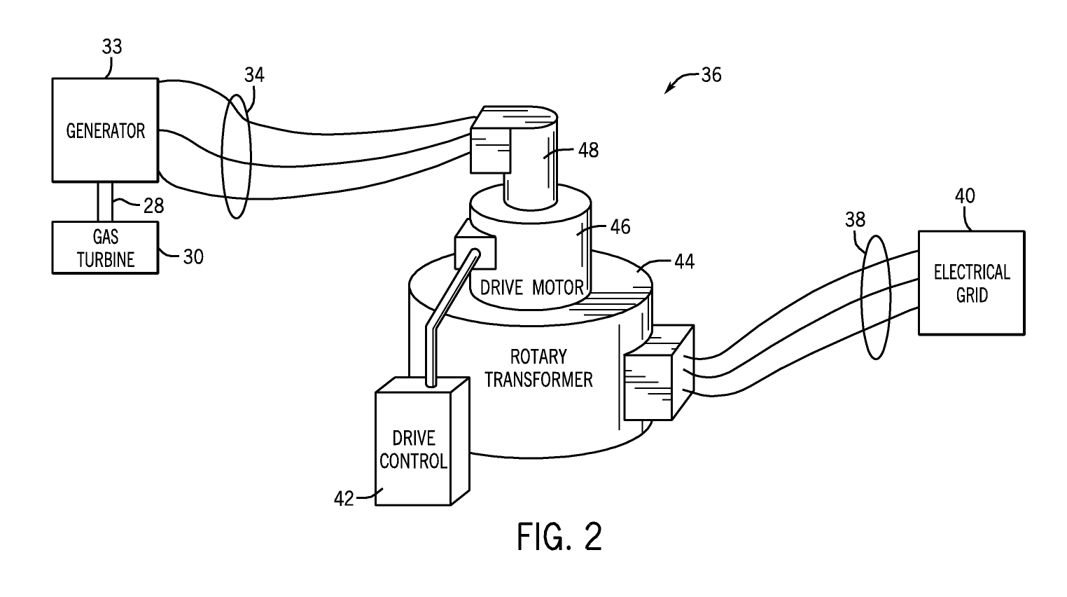

The VFT 36 is based on a combination of hydro generator and transformer technologies. Generally, the VFT 36 includes a rotary transformer for continuously controlling the phase shift and a drive control for adjusting the angle and the speed of the rotary transformer. As a result, the rotary transformer and the drive control regulate the power flow through the VFT 36. Additional details with regard to the VFT 36 are described below with reference to FIG. 2.

In one embodiment, the VFT 36 may allow exchanges of power between the generator 33 and the electrical grid 40 while maintaining a rated shaft speed (e.g., 3600 rpm) of the gas turbine 30. As such, the gas turbine 30 may operate at its rated shaft speed while connected to weak electrical grids where the frequency fluctuates. By operating at its rated shaft speed while the VFT 36 is connected to various grid frequencies, the gas turbine 30 may provide more efficient power output and may avoid equipment damage within the gas turbine 30 due to the various grid frequencies. As such, the gas turbine-VFT system 10 provides an improved ability to operate in a soft grid, where frequency varies.

In another embodiment, the VFT 36 may enable the gas turbine 30 to satisfy electrical grid code regulations in the electrical grid 40 during an under-frequency event. For instance, countries like Saudi Arabia may have a grid code that may require gas turbine rated active power to be maintained for a 0.5 Hz frequency drop and that any decrease in active power output between 57 and 59.5 Hz be no more than a proportionate decrease in the grid frequency. To meet this requirement, the gas turbine 30 may generate additional power output via the generator 33. Rather than increasing the power output by the generator 33 in ways that could cause damage and/or that might not be cost effective (e.g., by injecting water into the gas turbine 30, increasing the firing temperature of the gas turbine 30, conditioning the inlet air of the gas turbine 30, keeping an inlet guide vane (IGV) margin, or the like) the gas turbine-VFT system 10 may allow the gas turbine 30 to continue to operate at its rated frequency while reacting to an under-frequency event.

Indeed, by using the gas turbine-VFT system 10 described above, the gas turbine 30 may operate at its rated frequency even though it may be different from the frequency of the electrical grid 40. Since a gas turbine is generally designed to operate at its rated frequency (e.g., 60 Hz), the gas turbine-VFT system 10 helps enable the gas turbine 30 to operate more efficiently and avoid damage that may occur due to operating at frequencies other than its rating. As a result, the electrical power input into the electrical grid 40 may meet various electrical code power requirements during under-frequency events without requiring the gas turbine 30 to alter its frequency.

In addition to providing more efficient electrical grid code response, the gas turbine VFT system 10 may also enable the gas turbine 30 to remain connected to the electrical grid 40 event during large changes in the frequency of the electrical grid 40, for indefinite periods of time without resulting in any damage to the gas turbine 30. The ability to operate for a determined duration at off-frequency conditions is also a common grid code requirement. Further, by combining the VFT 36 with the gas turbine 30 and the generator 33, standard 60 Hz gas turbines may be used to connect to a 50 Hz electrical grid as used in countries such as Japan where both 50 Hz and 60 Hz grids exist, and Saudi Arabia which has a 60 Hz system but is surrounded by countries that employ 50 Hz grids.

FIG. 2 is a block diagram of an embodiment of the VFT 36 in the gas turbine-VFT system 10 that may incorporate one or more aspects of the presently disclosed technologies or techniques. As mentioned above, the VFT 36 may be connected to transfer electrical power between two asynchronous electrical systems such as the generator 33 and the electrical grid 40. The VFT 36 may include a drive control system 42, a rotary transformer assembly 44, and a drive motor 46 (also known as the rotor drive motor) which may be used to control a torque applied on the rotor of the VFT 36. The drive control system 42 may be employed to control the drive motor 46. The rotary transformer assembly 44 may include both a rotor subassembly and a stator (not shown). In one embodiment, the VFT 36 employs high power cables for the windings of both the rotor subassembly and the stator. A high power collector 48 may transfer power between the generator 33 and the rotor of the VFT 36. The stator cables of the VFT 36 may be connected to the electrical grid 40.

In another embodiment, the generator 33 may be connected to the stator of the VFT 36, and the electrical grid 40 may be connected to the high power collector 48. In addition, traditional step-up or step-down transformers (not shown) may be used with the VFT 36 to interface with the electrical grid 40 and the gas turbine generator 33.

The drive motor 46 rotates the rotor subassembly in response to a drive signal generated by the drive control system 42. The generator 33 and the electrical grid 40 may have differing electrical characteristics (e.g., frequency). The drive control 42 may bi-directionally operate the rotor subassembly at a variable speed for transferring power from the generator 33 to the electrical grid 40 or vice versa (i.e., from the electrical grid 40 to the generator 33). As a result, the VFT 36 may be capable of providing a bi-directional asynchronous link using the rotary transformer assembly 44. Further, the drive control system 42 that adjusts the angle and speed of the rotary transformer assembly 44 may be used to regulate the power flow through the VFT 36.

By using the VFT 36 in conjunction with the gas turbine 30 and the generator 33, the gas turbine-VFT control system 50 may control the frequency of the power output of the generator 33, and therefore the speed of the gas turbine 30, independent of grid frequency fluctuations. In this manner, the gas turbine VFT system 10 avoids hardware damage that may result in the gas turbine 30 when increasing the power output from the generator 33 by increasing the fuel flow and/or the air flow of the gas turbine 30.

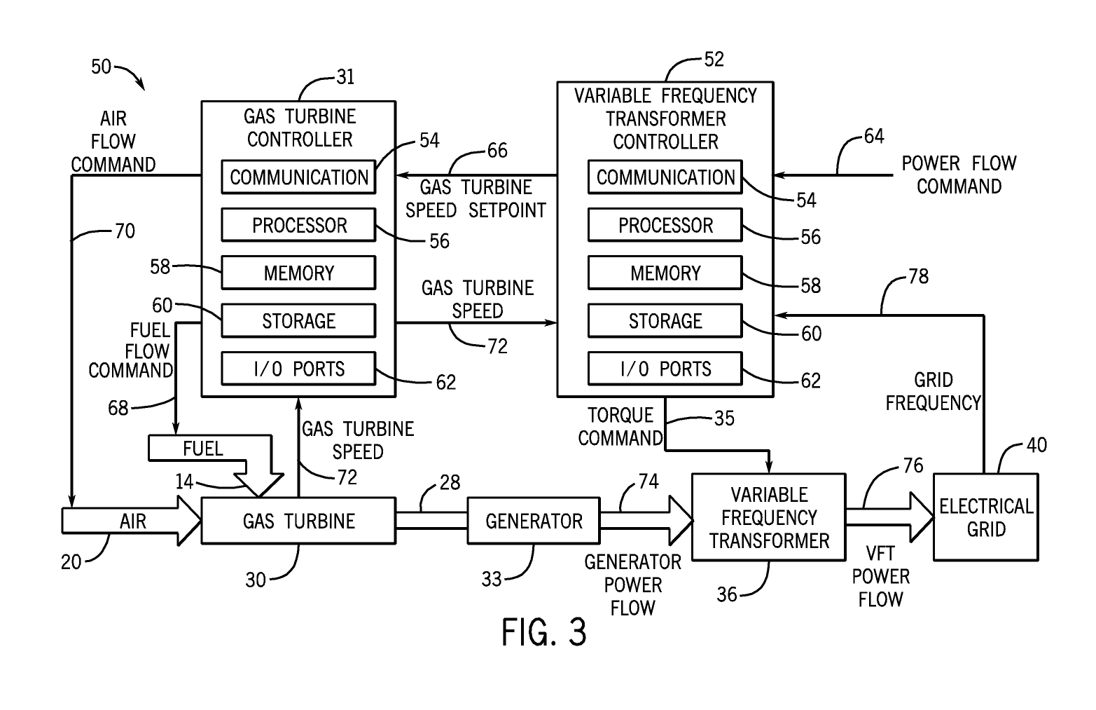

FIG. 3 is a block diagram of a gas turbine-VFT control system 50 to control the gas turbine-VFT system 10. In one embodiment, a VFT controller 52 may be configured to control the VFT 36. The VFT controller 52 may include a communication module 54, a processor 56, a memory 58, a storage 60, and input/output (I/O) ports 62. The communication module 54 may be a wireless or wired communication module that may facilitate communication between the VFT 36 and the gas turbine 30. The processor 56 may be any type of computer processor or microprocessor capable of performing the presently disclosed techniques.

In one embodiment, the VFT controller 52 may receive a power flow command 64 from a user, which may specify a power output value (e.g., 185 MW) from the VFT 36. The power flow command 64 may also be generated by an external control system and may include electrical grid code requirements that specify the power output requirements for the VFT 36 in various situations (e.g., under-frequency events).

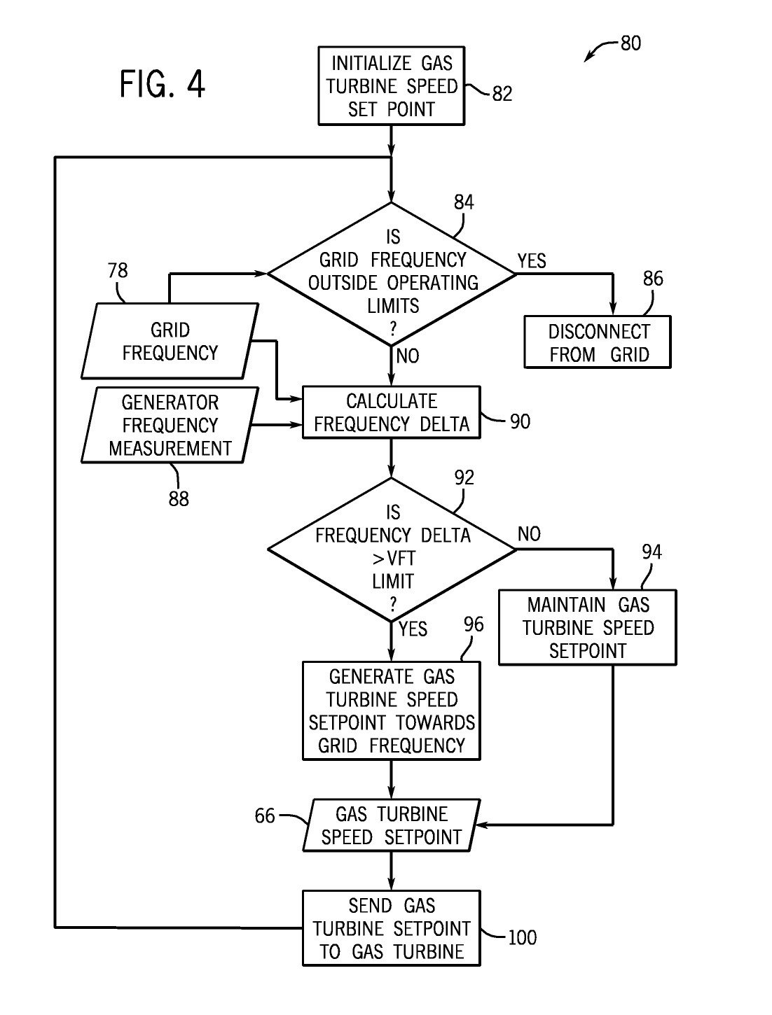

After receiving the power flow command 64, the processor 56 may determine a gas turbine speed setpoint 66 for the gas turbine 30. In general, the processor 56 may determine the gas turbine speed setpoint 66 based on a nominal speed specified for the gas turbine 30. However, in some embodiments, the processor 56 may determine the gas turbine speed setpoint 66 based on inherent limitations of the VFT 36. Additional details with regard to how the processor 56 may determine the gas turbine speed setpoint 66 will be discussed below with reference to FIG. 4.

After determining the gas turbine speed setpoint 66, the VFT controller 52 may send the gas turbine speed setpoint 66 to a gas turbine controller 31 via communication module 54. In one embodiment, the gas turbine controller 31 may be configured to control the gas turbine 30. Like the VFT controller 52, the gas turbine controller 31 may include a communication module 54, a processor 56, a memory 58, a storage 60, and input/output (I/O) ports 62. The descriptions for these components correspond to the descriptions provided above with regard to the same components in the VFT controller 52. The gas turbine controller 31 may then receive the gas turbine speed setpoint 66 as a speed reference for isochronous speed control of the gas turbine 30 (i.e., fixed speed control). The gas turbine controller 31 may provide a fuel flow command 68 and an airflow command 70 to adjust the fuel flow 14 and the air flow 20 of the gas turbine 30 such that the gas turbine 30 achieves a gas turbine speed 72 specified by the gas turbine speed setpoint 66. As a result, the gas turbine 30 may rotate the generator 33 using the shaft 28 such that the generator 33 may produce electrical power (i.e., generator power flow 74).

The VFT 36 may receive the generator power flow 74 and the VFT controller 52 may regulate or adjust a torque command 35 to the drive motor of the VFT 36 to enable the VFT 36 to allow for a VFT power flow 76 that corresponds to the power output (e.g., 185 MW) specified in the power flow command 64.

Changes to the torque command 35 may create a temporary load imbalance on the gas turbine 30, which may cause the gas turbine speed 72 to either rise or drop. In this case, the gas turbine controller 31 may adjust the fuel flow command 68 and the air flow command 70 to adjust the gas turbine speed 72 until it is equal to the gas turbine speed setpoint 66, at which point the generator power flow 74 is such that the VFT power flow 76 substantially matches the power flow command 64.

The VFT 36 may automatically compensate for changes in the frequency of the electrical grid (i.e., grid frequency 78) such that the gas turbine 30 continuously operates at the gas turbine speed setpoint 66 (i.e., nominal speed). Accordingly, the gas turbine-VFT system 10 may be used to maintain the frequency of the generator power flow 74 during grid under-frequency events without burdening the gas turbine 30. That is, the VFT 36 may provide the power flow 76 to the electrical grid 40 that has a substantially similar frequency as the electrical grid 40 (i.e., grid frequency 78) without requiring the gas turbine 30 to operate at a gas turbine speed 58 that is different from its nominal speed.

In order for the VFT 36 to automatically compensate for changes in the grid frequency 78, the VFT controller 52 may receive the grid frequency 78 from the electrical grid 40 in addition to the power flow command 64. The grid frequency 78 may be acquired using one or more sensors connected to the I/O ports 62. As the grid frequency 78 changes, the VFT controller 52 may send a command to the drive motor 42 (FIG. 2) to adjust the speed of the VFT rotor such that the frequency of the VFT power flow 76 substantially matches the grid frequency 78. In this manner, the VFT 36 may allow for uninterrupted power transfer between the generator 33 and the electrical grid 40, even though they may not be synchronized. In addition to regulating the power flow between the generator 33 and the electrical grid 40, the VFT rotor may inherently orient itself to match the phase angle forced by the two asynchronous systems (the generator 33 and the electrical grid 40).

In one embodiment, the VFT 36 may have a maximum differential frequency that may be accommodated between the generator power flow 74 and VFT power flow 76. Accordingly, if the difference in the frequency between generator power flow 74 and the VFT power flow 76 is too large for the VFT 36 to accommodate, the VFT 36 may not be able to maintain the gas turbine 30 at its nominal speed if the grid frequency 78 drops too low. For example, suppose the maximum differential frequency that the VFT 36 can accommodate is 3 Hz and that the frequency of the electrical grid 40 falls such that the frequency of the generator power flow 74 differs from the grid frequency 78 by more than 3 Hz. In this case, the VFT 36 will not be able to make up for the frequency difference between the two systems because the adjustment may be beyond the intrinsic capability of the VFT 36. As such, the gas turbine speed 72 may be lowered such that the frequency of the generator power flow 74 is within 3 Hz of the grid frequency 78. Additional details with regard to adjusting the gas turbine speed setpoint 66 to keep the generator power flow 74 within the limits of the VFT 36 capability is described below with reference to FIG. 4.

In another embodiment, as mentioned above, the power flow command 64 may include electrical grid code regulations for power supplied by the generator 33 to the electrical grid 40. Here, if the difference between the frequency of the generator power flow 74 and the grid frequency 78 is within the maximum differential frequency of the VFT 36, the VFT 36 may allow the gas turbine 30 to operate at its rated speed and produce its rated output without any modifications should the grid frequency 78 be lower than its nominal frequency, thereby satisfying the electrical grid code regulations.

FIG. 4 is a data flow diagram 80 that provides one example of adjusting a frequency of a power output by a gas turbine-VFT system 10. Although data flow diagram 80 indicates a particular order of operation, it should be understood that the data flow diagram 80 is not limited to the illustrated order. Instead, the data flow diagram 80 may be performed in any order. In one embodiment, the process described in the data flow diagram 80 may be performed by the VFT controller 52 as described above in FIG. 3.

At block 82, the gas turbine speed setpoint 66 may be initialized to a nominal gas turbine speed (e.g., 3600 rpm). At block 84, the VFT controller 52 may receive the grid frequency 78 and compare the grid frequency 78 to one or more operating limits. If the grid frequency 78 is outside the operating limit(s), the VFT controller 52 may send a command to a breaker or a similar device to disconnect the gas turbine-VFT system 10 from the electrical grid 40 (i.e., block 86) as a protective measure. Alternatively, if the grid frequency 78 is within operating limits, the VFT controller 52 may proceed to block 90 and calculate a frequency delta. The frequency delta is the difference between the grid frequency 78 and a generator frequency measurement 88. The generator frequency measurement 88 may correspond to the frequency of the power output of the generator 33 (i.e., generator power flow 74).

At block 92, the VFT controller 52 may determine whether the frequency delta is greater than a VFT limit. The VFT limit may correspond to the maximum differential frequency that the VFT 36 may accommodate between the generator power flow 74 and the VFT power flow 76. If the frequency delta is less than or equal to the VFT limit, the VFT controller 52 may maintain the gas turbine speed setpoint 66 at its current speed (i.e., block 94).

Alternatively, if the frequency delta is greater than the VFT limit, at block 96, the VFT controller 52 may generate a gas turbine speed setpoint 66 such that the generator frequency measurement 88 moves closer to the grid frequency 78. That is, the VFT controller 52 may decrease or increase the gas turbine speed setpoint 66 such that the frequency of the power output of the gas turbine 30 may be reduced or increased. By reducing or increasing the frequency of the power output of the gas turbine 30, the frequency delta may become closer to the VFT limit to help enable the gas turbine-VFT system 10 to meet the grid frequency 78.

At block 100, the VFT controller 52 may send the gas turbine speed setpoint 66 to the gas turbine controller 31. After sending the gas turbine speed setpoint 66 to the gas turbine 30, the VFT controller 52 may return to block 84 and repeat the process of data flow diagram 80 until the frequency delta is within the VFT limit. Once the frequency delta is less than or equal to the VFT limit, the VFT 36 may then be able to alter the generator power flow 74 such that the VFT power flow 76 corresponds to the power flow command 64 and the frequency of the VFT power flow 76 matches the grid frequency 78.

In one embodiment, as the gas turbine speed decreases, the generator power flow 74 may also decrease. In this case, the gas turbine-VFT system 10 may compensate for the decreased power output of the generator power flow 74 by increasing fuel flow 68 and or the air flow 70 in the gas turbine 30.

Although the VFT controller 52 and the gas turbine controller 31 have been described above as two separate controllers, it should be noted that the VFT controller 52 and the gas turbine controller 31 may be incorporated into a single controller, which may be installed on any component in the gas turbine-VFT system 10 or as a separate component in the gas turbine-VFT system 10.

Technical effects of the present disclosure include, among other things, automatically compensating for changes in the frequency of the electrical grid (i.e., grid frequency 78) such that the gas turbine 30 continuously operates at the gas turbine speed setpoint 66 (i.e., nominal speed). Accordingly, the gas turbine 30 may operate at its rated speed, thereby increasing the life and efficiency of the gas turbine 30.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas turbine;
a generator coupled to the gas turbine and configured to generate a first electrical power output; and
a variable frequency transformer coupled to the generator and configured to be coupled to an electrical grid, wherein the variable frequency transformer is configured to transform the first electrical power output into a second electrical power output having one or more power characteristics that correspond to the electrical grid.

2. The system of claim 1, wherein the power characteristics comprise at least a frequency of the electrical grid.

3. The system of claim 1, wherein the power characteristics comprise one or more electrical grid code requirements for the electrical grid.

4. The system of claim 1, further comprising gas turbine controls configured to operate the gas turbine in an islanding mode.

5. The system of claim 1, comprising a first controller configured to:
receive a power command having a power value;
determine a gas turbine speed setpoint based at least in part on one or more characteristics of the gas turbine, the power command, a frequency of the electrical grid, or any combination thereof; and
send the gas turbine speed setpoint to the gas turbine.

6. The system of claim 5, wherein the gas turbine comprises a second controller configured to adjust a fuel flow, an air flow, or any combination thereof to the gas turbine until a gas turbine speed is substantially similar to the gas turbine speed setpoint.

7. The system of claim 5, wherein the first controller is configured to adjust a fuel flow, an air flow, or any combination thereof to the gas turbine until a gas turbine speed is substantially similar to the gas turbine speed setpoint.

8. The system of claim 1, wherein the variable frequency transformer transforms the first electrical power output by adjusting at least a phase angle, a torque, a speed, or any combination thereof of a rotary transformer inside the variable frequency transformer.

9. A non-transitory computer-readable medium having computer-executable instructions stored thereon for execution by a processor for performing a method, comprising:
receiving a power command having an electrical power output value for a variable frequency transformer, wherein the variable frequency transformer receives a first electrical power from a gas turbine generator; and
sending a first command to the variable frequency transformer to adjust a second electrical power from the variable frequency transformer to substantially match the electrical power output value, wherein the variable frequency transformer automatically compensates for a difference between a first frequency of the first electrical power and a second frequency of the second electrical power.

10. The non-transitory computer-readable medium of claim 9, wherein the first command comprises one or more instructions configured to adjust a rotor speed, a torque, a phase angle, or any combination thereof of the variable frequency transformer until the second electrical power substantially matches the electrical power output value.

11. The non-transitory computer-readable medium of claim 9, wherein the method comprises sending a second command to a breaker coupled between the electrical grid and the variable frequency transformer to open when a third frequency of the electrical grid is greater than a predetermined limit.

12. The non-transitory computer-readable medium of claim 9, wherein the power command comprises one or more electrical grid code requirements for the electrical grid.

13. The non-transitory computer-readable medium of claim 9, wherein the gas turbine operates at a nominal speed while the variable frequency transformer automatically compensates for the difference between the first frequency and the second frequency.

14. A method for generating power, comprising:
(a) receiving a first frequency that corresponds to an electrical grid;
(b) receiving a second frequency that corresponds to an electric power output by a generator coupled to a gas turbine and a variable frequency transformer, wherein the variable frequency transformer is coupled to the electrical grid;
(c) generating a gas turbine speed setpoint based at least in part on the first frequency and the second frequency;
(d) sending the gas turbine speed setpoint to the gas turbine;
(e) repeating steps (a)-(d) until a difference between the first frequency and the second frequency is less than or equal to a predetermined value; and
(f) sending a command to the variable frequency transformer to adjust an electric power output by the variable frequency transformer to substantially match an electric power output value specified by a power command.

15. The method of claim 14, wherein the predetermined value corresponds to a maximum differential frequency of the variable frequency transformer.

16. The method of claim 14, wherein the gas turbine speed setpoint generated at step (c) is set to a nominal speed of the gas turbine if the difference between the first frequency and the second frequency is less than the predetermined value.

17. The method of claim 14, wherein the generated gas turbine speed setpoint is different from a nominal speed of the gas turbine if the difference is greater than the predetermined value.

18. The method of claim 17, comprising sending one or more commands to the gas turbine to modify an air flow, a fuel flow, or any combinations thereof.

19. The method of claim 18, wherein the modified air flow, fuel flow, or any combinations thereof are configured to alter the electrical power output by the generator.

20. The method of claim 14, wherein the command comprises a rotor speed adjustment, a torque adjustment, a phase angle adjustment, or any combination thereof for a rotary transformer in the variable frequency transformer.
